(19) United States
(12) Patent Application Publication
(10) Pub. No.: US 2025/0013432 A1
(43) Pub. Date: Jan. 9, 2025

(54) Custom Scratchpad Memory For Partial Dot Product Reductions

(71) Applicant: Google LLC, Mountain View, CA (US)

(72) Inventors: Vinayak Anand Gokhale, Austin, TX (US); Matthew Leever Hedlund, Sun Prairie, WI (US); Rahul Nagarajan, San Jose, CA (US); Naveen Muralimanohar, San Jose, CA (US); Shriram Nagarajan, Santa Clara, CA (US)

(21) Appl. No.: 18/218,448

(22) Filed: Jul. 5, 2023

(51) Int. Cl. G06F 7/544; G06F 7/50; G06F 7/533

(52) U.S. Cl. CPC G06F 7/5443; G06F 7/50; G06F 7/533

(57) ABSTRACT

Aspects of the disclosed technology include techniques and mechanisms for using a custom scratchpad memory for partial dot product reductions. The custom scratchpad memory may be a special purpose memory that is dedicated to receiving and storing partial dot products determined by matrix multiplier units. Each partial dot product may correspond to tiles of a resultant matrix, where the resultant matrix is the product of matrix multiplication that can use a first matrix representing a user query as a left-hand side operand and a second matrix representing a trained model containing data that may be used to respond to the user query as a right-hand side operand. The custom scratchpad memory may append the tiles determined by the matrix multiplication, where the appended tiles may create the resultant matrix. Custom scratchpad memory may write the resultant matrix to general purpose memory, where it may be used to respond to the user query.

### BACKGROUND

Current computing chips, such as hardware accelerators, within computing devices may compute data using matrix multiplication. Two matrices may be used to perform matrix multiplication, for example a matrix A and a matrix B, where the matrix multiplication may be denoted as A×B.

A computing device may use two primary memory levels to perform the matrix multiplication—general purpose memory and register files. Register files may have a smaller storage capacity than the general purpose memory, but may be a lower power and higher bandwidth storage option. Due to the smaller memory capacity of the register files, any data that exceeds the storage capacity of the register files may be written to the general purpose memory. The general purpose memory may have a larger storage capacity than the register files, but may have lower bandwidth. To compute matrix C, matrices A and B may be written to the general purpose memory.

The computing device may read subsections of matrices A and B from the general purpose memory to perform the matrix multiplication. A first tile may be extracted from matrix A and a second tile may be extracted from matrix B. The first tile may be multiplied against the second tile using a matmul ( ) function to produce a partial product tile of matrix C. The computing device may write the resultant tile of matrix C to the register files or, if the register files are at maximum storage capacity, to the general purpose memory. The computing device may read tiles of matrix C from the general purpose memory and may combine the determined resultant tiles using element-wise addition to generate a portion of matrix C, which may be written back to the general purpose memory. The generated portion of matrix C may be repeatedly read from the general purpose memory, appended to newly generated tiles of matrix C, and written back to the general purpose memory until the entirety of matrix C is generated.

The computing device may repeatedly execute matmul ( ) functions until the entirety of matrix A is multiplied against the entirety of matrix B to produce the entirety of matrix C. Each repetition of the matrix multiplication may include reading two tiles from the general purpose memory and writing the produced partial product tile of matrix C to the general purpose memory. Depending on the size of matrices A and B, repeatedly reading from and writing to the general purpose memory may lead to processing delays and may consume a significant amount of power and bandwidth.

Further, as the computing power of the computing device increases, the demand on memory may also increase, but current memory storage capacities might not increase as quickly as computing power increases. This problem is further compounded by the general purpose memory storing additional data that the computing device may need to run and execute other user applications and programs. Therefore, constantly reading from and writing to the general purpose memory and sharing the general purpose memory capacity with data used for other operations may affect front-end user-facing applications that rely on matrix multiplication to generate a response to a user query and to provide the response to the user. Namely, a delay in performing the matrix multiplication to generate resultant matrix C may lead to a delay in responding to the user query.

### SUMMARY

Aspects of the disclosed technology include methods, apparatuses, systems, and computer-readable media associated with using a custom scratchpad memory for partial dot product reductions. The custom scratchpad memory may be a special purpose memory that is dedicated to receiving and storing partial dot products determined by matrix multiplier units. Each partial dot product may correspond to tiles of a resultant matrix. The resultant matrix may be the product of matrix multiplication that uses a first matrix as a left-hand side operand and a second matrix as a right-hand side operand. Performance of the matrix multiplication may generate one or more tiles of the resultant matrix. The custom scratchpad memory may append the tiles determined by the matrix multiplication and the appended tiles may create a resultant matrix. Custom scratchpad memory may write the resultant matrix to general purpose memory. In some instances, a processing element may perform read and write transactions to and from the custom scratchpad memory. A computing device may read the resultant matrix from the general purpose memory.

The use of the custom scratchpad memory may reduce a number of read and write transactions executed on the general purpose memory. For example, the partial product tiles produced by multiplying the first and second matrices may be stored in the custom scratchpad memory. Repeated read and write transactions may be executed on the custom scratchpad memory to read the stored partial product tiles and to write subsequently determined partial product tiles to the custom scratchpad memory, thereby freeing up general purpose memory to execute other applications. Further, since the first and second matrices may be stored in the custom scratchpad memory along with arrays extracted from the first and second matrices, determining partial dot product reductions might not rely on read and write transactions executed on the general purpose memory. Since the general purpose memory may be used to store data and instructions needed to execute other applications on a computing device, access to the general purpose memory to perform matrix multiplication and determine partial dot product results may be limited. Therefore, the custom scratchpad memory provides for a dedicated computing environment that may be smaller and faster than the general purpose memory, and may allow for efficient execution of the matrix multiplication and partial dot products that may be used, for example, to generate responses to user queries.

One aspect of the disclosure provides a system for determining partial dot product reductions, the system comprising: a special purpose memory; one or more computing devices configured to communicate with the special purpose memory and a general purpose memory; and instructions that, when executed, cause the one or more computing devices to: receive, from matrix multiplier units configured to perform matrix multiplication and associated with the one or more computing devices, a partial dot product between a first tile and a second tile, wherein the first tile is extracted from a first matrix and the second tile is extracted from a second matrix; store the received partial dot product; append the received partial dot product to previously determined partial dot products stored in the special purpose memory; generate a resultant matrix based on the appending; and write the resultant matrix to the general purpose memory.

According to some examples, the first tile comprises column elements extracted from the first matrix. According to some examples, the second tile comprises row elements extracted from the second matrix. According to some examples, the instructions, when executed, further cause the one or more computing devices to store the first tile and the second tile.

According to some examples, the instructions, when executed, further cause the one or more computing devices to store an updated first tile, wherein the updated first tile comprises new column elements extracted from the first matrix, and wherein the new column elements of the updated first tile are different from column elements of the first tile.

According to some examples, the instructions, when executed, further cause the one or more computing devices to store an updated second tile, wherein the updated second tile comprises new row elements extracted from the second matrix, and wherein the new row elements of the updated second tile are different from row elements of the second tile.

According to some examples, the instructions, when executed, further cause the one or more computing devices to receive, from the matrix multiplier units, subsequent partial dot products between: an updated first tile and the second tile; and the first tile and an updated second tile.

In the foregoing embodiments, the instructions, when executed, further cause the one or more computing devices to store subsequent partial dot products received from the matrix multiplier units.

In some examples, each of the partial dot product and subsequent partial dot products correspond to tiles of the resultant matrix.

In the foregoing embodiments, the appending further causes the one or more computing devices to: locate, within the special purpose memory, the tiles of the resultant matrix, wherein the tiles are based on the partial dot product and the subsequent partial dot products; and accumulate, using adders, the located tiles to create a partial resultant matrix until a totality of the located tiles generates the resultant matrix.

In the foregoing embodiments, the instructions, when executed, cause the one or more computing devices to: store the partial resultant matrix; and append, using the adders, additional tiles of the resultant matrix to the stored partial resultant matrix to generate an updated partial resultant matrix until the resultant matrix is generated.

In the foregoing embodiments, the instructions, when executed, further cause the one or more computing devices to append, using adders, the received partial dot product to previously determined partial dot products until a totality of receive partial dot products indicates that an entirety of the first matrix was multiplied against an entirety of the second matrix.

Another aspect of the disclosure provides a method for determining partial dot product reductions using a special purpose memory, the method comprising: receiving, by the special purpose memory and from matrix multiplier units configured to perform matrix multiplication, a partial dot product between a first tile and a second tile, wherein the first tile is extracted from a first matrix and the second tile is extracted from a second matrix; storing, by the special purpose memory, the received partial dot product; appending, by the special purpose memory, the received partial dot product to previously determined partial dot products stored in the special purpose memory; generating, by a computing device comprising the special purpose memory, a resultant matrix based on the appending; and writing, by the computing device, the resultant matrix to a general purpose memory.

In the foregoing embodiment, the method further comprises receiving, by the special purpose memory and from the matrix multiplier units, subsequent partial dot products between: an updated first tile and the second tile, wherein the updated first tile comprises new column elements extracted from the first matrix, and wherein the new column elements of the updated first tile are different from column elements of the first tile; and the first tile and an updated second tile, wherein the updated second tile comprises new row elements extracted from the second matrix, and wherein the new row elements of the updated second tile are different from row elements of the second tile.

In some examples, each of the partial dot product and subsequent partial dot products correspond to tiles of the resultant matrix.

In some examples, the appending further comprises: locating, by the special purpose memory, the tiles of the resultant matrix, wherein the tiles are based on the partial dot product and the subsequent partial dot products; and accumulating, by the special purpose memory and using adders, the located tiles to create a partial resultant matrix until a totality of the located tiles generates the resultant matrix.

In the foregoing embodiments, the method further comprises storing, by the special purpose memory, the partial resultant matrix; and appending, by the special purpose memory and using the adders, additional tiles of the resultant matrix to the stored partial resultant matrix to generate an updated partial resultant matrix until the resultant matrix is generated.

Another aspect of the disclosure provides a non-transitory computer readable storage medium storing instructions that, when executed by a computing device comprising one or more processors, special purpose memory, and general purpose memory, cause the computing device to: receive, from matrix multiplier units configured to perform matrix multiplication, a partial dot product between a first tile and a second tile, wherein the first tile is extracted from a first matrix and the second tile is extracted from a second matrix; store the received partial dot product in the special purpose memory; append the received partial dot product to previously determined partial dot products stored in the special purpose memory; generate a resultant matrix based on the appending; and write the resultant matrix to the general purpose memory.

In some examples, the instructions, when executed, further cause the computing device to store the first tile and the second tile in the special purpose memory.

In some examples, the instructions, when executed, further cause the computing device to receive, from the matrix multiplier units, subsequent partial dot products between: an updated first tile and the second tile, wherein the updated first tile comprises new column elements extracted from the first matrix, and wherein the new column elements of the updated first tile are different from column elements of the first tile; and the first tile and an updated second tile, wherein the updated second tile comprises new row elements extracted from the second matrix, and wherein the new row elements of the updated second tile are different from row elements of the second tile.

### BRIEF DESCRIPTION OF THE DRAWINGS

FIG. 1 illustrates an example matrix multiplication that may use a custom scratchpad memory for partial dot product reductions, in accordance with aspects of the disclosure.

FIG. 2 illustrates a block diagram of an example environment where a custom scratchpad memory may be used for determining partial dot product reductions, in accordance with aspects of the disclosure.

FIG. 3 illustrates a flow diagram for an example method of using the custom scratchpad memory for partial dot product reductions, in accordance with aspects of the disclosure.

FIG. 4 illustrates example addition of partial results of a resultant matrix, in accordance with aspects of the disclosure.

FIG. 5 illustrates an example process or method of using the custom scratchpad memory for partial dot product reductions, in accordance with aspects of the disclosure.

### DETAILED DESCRIPTION

This technology relates to using a custom scratchpad memory for partial dot product reductions. The technology described herein addresses a custom scratchpad memory for partial dot product reductions. The custom scratchpad memory may be a smaller, special purpose memory to store partial results of matrix multiplication, such as partial product tiles of a resultant matrix C that are generated in each iteration of the multiplication of matrices A and B, denoted by A×B. In some instances, the custom scratchpad memory may be referred to herein as a partial results buffer that is used to store the partial results of the matrix multiplication. The custom scratchpad memory may be used in place of storing the partial results of matrix multiplication in the general purpose memory. This may reduce the number of read transactions from and write transactions to the general purpose memory until the entirety of matrix C has been generated and can be stored in the general purpose memory.

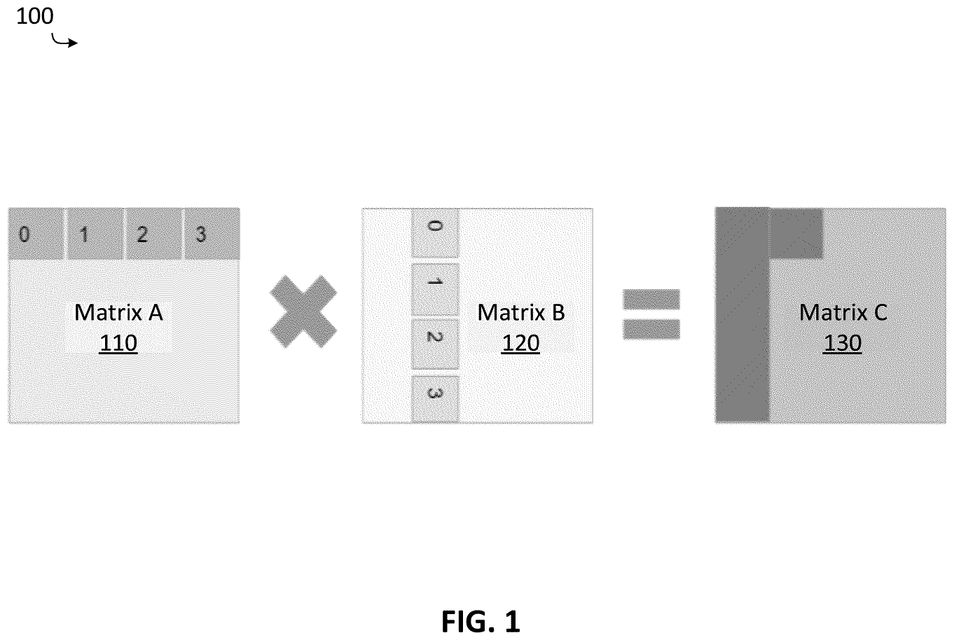

FIG. 1 illustrates an example matrix multiplication operation that may use the custom scratchpad memory for determining partial dot product reductions, in accordance with aspects of the disclosure. Partial dot products may be determined based on matrix multiplication performed on matrices A and B, denoted as A. B. For example, a computing device may execute matrix multiplication 100 using matrix A 110 and matrix B 120. Matrix A 110 may be a left-hand side (LHS) operand and may represent a user input, such as a search query, an image, input text, or the like. In some examples, matrix A may include input to a neural network layer or other portion of a machine learning model; output from a previous neural network layer to a subsequent neural network layer; learned embeddings mapped to input to a machine learning model; text or other data that is encoded to a numerical representation, e.g., integers, floating point values, or numbers in other numerical formats with varying degrees of precision; pixel values of an image or frame of a video; feature values for one or more inputs to a machine learning model, etc. Matrix B 120 may be a right-hand side (RHS) operand and may represent a trained model or a portion of a trained model, e.g., weights or bias values for a neural network layer.

For example, data in matrix A 110 may include a user query that is submitted to an automated search engine or automated chatbot, e.g., using a large language model, which may be represented by matrix B 120. Matrix multiplication 100 may be used to run the user query through the search engine or chatbot to generate a response to the user query, where the response is based on information available in matrix B 120. The output of the matrix multiplication of matrices A 110 and B 120 may be the resultant matrix C 130, which may contain the response to the user query that may be transmitted back to the user or to another neural network layer.

Matrix B 120 may be loaded into one or more systolic arrays. The size of matrices A 110 and B 120, may depend on the application, but the size and shape of the plurality of systolic arrays that are used in matrix multiplication 100, such as for matrix B 120, may be fixed. Matrix B 120 may be cached within an array, e.g., a systolic array, and matrix A 110 may be streamed through matrix B 120 to produce matrix C 130, which may be denoted as \vec{A}·\vec{B}=\vec{C}. Matrix multiplication 100 is discussed in greater detail in the following figures, described below.

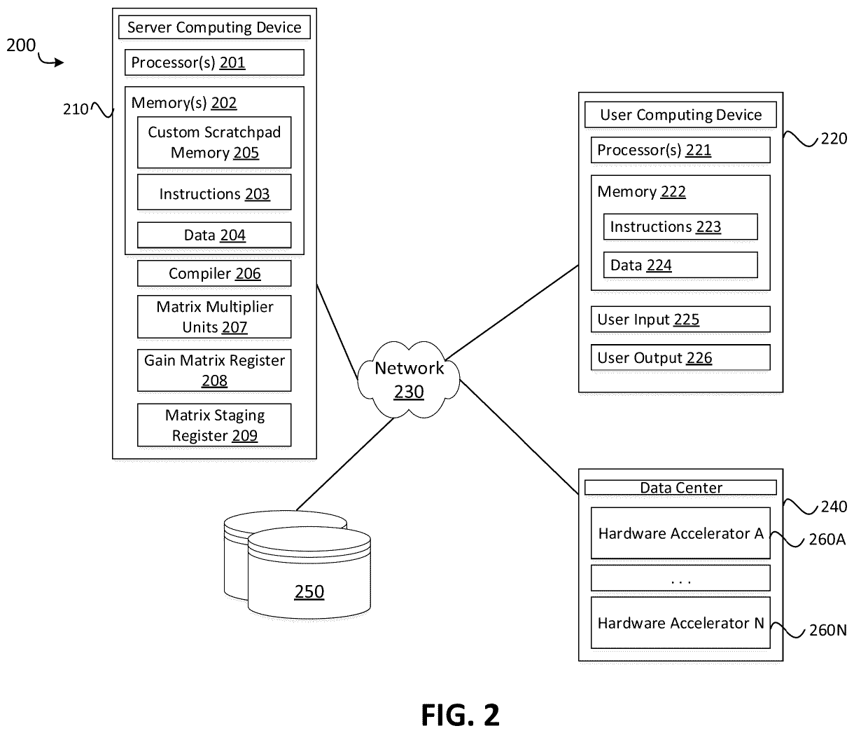

FIG. 2 illustrates a block diagram of an example environment where a custom scratchpad memory may be used for determining partial dot product reductions, in accordance with aspects of the disclosure. Matrix multiplication 100 may be implemented using one or more devices having one or more processors in one or more locations, such as server computing device 210 and user computing device 220 in computing environment 200. Server computing device 210 and user computing device 220 may be communicatively coupled to one or more storage devices over a network. The storage devices may be a combination of volatile and non-volatile memory and may be at the same or different physical locations than the computing devices. For example, the storage devices may include any type of non-transitory computer readable medium capable of storing information, such as a hard-drive, solid state drive, tape drive, optical storage, memory card. ROM, RAM, DVD, CD-ROM, write-capable, and read-only memories. In some instances, database 250 may store data transmitted across network 230 and between server computing device 210, user computing device 220, and data center 240.

Server computing device 210 may include one or more processors and memory, such as processor(s) 201 and memory(s) 202, referred to herein as processor 201 and memory 202, respectively. Memory 202 may include custom scratchpad memory 205 and may correspond to additional memory locations associated with server computing device 210, discussed below. Memory 202 may also include instructions 203 and data 204. Server computing device 210 may further include compiler 206, matrix multiplier units (MXUs) 207, gain matrix register (GMR) 208, and matrix staging register (MSR) 209. In some instances, MXUs 207, GMR 208, and MSR 209 may be part of memory 202.

Memory 202 may store information accessible by processor 201, including instructions 203 that may be executed by processor 201. Memory 202 may also include data 204 that may be retrieved, manipulated, or stored by the processor 201. Memory 202 may be a type of non-transitory computer readable medium capable of storing information accessible by processor 201, such as volatile and non-volatile memory. Processor 201 may include one or more central processing units (CPUs), graphic processing units (GPUs), field-programmable gate arrays (FPGAs), and/or application-specific integrated circuits (ASICs), such as tensor processing units (TPUs).

In some instances, memory 202 may correspond to additional memory locations associated with server computing device 210, such as a high bandwidth memory (HBM) or virtual memory (Vmem). Server computing device 210 may read data, such as matrices, from either one of the HBM to the Vmem to determine the dot product reductions discussed below. For example, server computing device 210 may read, from the Vmem, matrices that may be used to execute the matrix multiplication.

In some instances, memory 202 may store instructions 203 and data 204 that correspond to additional operations, functions, and/or programs executed by server computing device 210. As such, memory 202 may be referred to as general purpose memory. As general purpose memory, the demand on memory 202 may increase as server computing device 210 performs functions or executes operations in addition to determining partial dot product reductions.

Therefore, memory 202 may dedicate custom scratchpad memory 205 to determining the partial dot product reductions. Custom scratchpad memory 205 may be a smaller, special purpose memory that may store the matrices used for executing matrix multiplication and determining partial dot product reductions. In some instances, server computing device 210 may read data or collect resources needed to determine the partial dot product reductions, such as matrices and a plurality of tiles extracted from the matrices, from at least memory 202 or data center 240. Server computing device 210 may write the plurality of tiles extracted from the matrices to custom scratchpad memory 205 such that the determination of partial dot product reductions is performed within custom scratchpad memory 205. Server computing device 210 may determine a resultant matrix based on the matrix multiplication and may write the resultant matrix to memory 202, where server computing device 210 may use the resultant matrix to generate a response to the user query.

The data within custom scratchpad memory 205 may persist for the duration of the matrix multiplication needed to generate a resultant matrix. Upon generation of the resultant matrix, server computing device 210 may wipe custom scratchpad memory 205 such that custom scratchpad memory 205 may receive and store new data needed to perform subsequent matrix multiplication operations to generate responses to subsequently received user queries.

Instructions 203 may include one or more instructions that, when executed by processor 201, cause processor 201 to perform actions defined by instructions 203. Instructions 203 may be stored in object code format for direct processing by processor 201, or in other formats including interpretable scripts or collections of independent source code modules that are interpreted on demand or compiled in advance. Instructions 203 may include instructions for determining partial dot product reductions according to matrix multiplication 100 of FIG. 1. The described matrix multiplication may be executed using processor 201 and/or using other processors remotely located from server computing device 210.

Data 204 may be retrieved, stored, or modified by processor 201 in accordance with the instructions. Data 204 may be stored in computer registers, in a relational or non-relational database as a table having a plurality of different fields and records, or as JSON, YAML, proto, or XML documents. Data 204 may also be formatted in a computer-readable format such as, but not limited to, binary values, ASCII, or Unicode. Moreover, data 204 may include information sufficient to identify relevant information, such as numbers, descriptive text, proprietary codes, pointers, references to data stored in other memories, including other network locations, or information that is used by a function to calculate relevant data.

Server computing device 210 may use compiler 206, MXUs 207, GMR 208, and MSR 209 to execute the matrix multiplication needed to determine partial dot product reductions. Server computing device 210 may use compiler 206 to read the plurality of tiles extracted from the matrices from memory 202 and to write the plurality of tiles to MXUs 207. MXUs 207 may stream a first tile through a second tile, where the first tile may be extracted from matrix A and the second tile may be extracted from matrix B. MXUs 207 may store the second tile and may multiply the first tile against the second tile. At some time in the future, MXUs 207 may finish multiplying the first tile against the second tile and may need an updated second tile extracted from matrix B. The updated second tile extracted from matrix B may be different from the tiles previously extracted from matrix B.

MXUs 207 may use a double buffer to store the updated second tile extracted from matrix B while the second tile extracted from matrix B is used to perform the matrix multiplication. The double buffer may store the tiles that are currently being used to perform the matrix multiplication as well as new tiles to be used to perform the matrix multiplication. In particular, the tile that is currently in use may be read, by MXUs 207, from GMR 208 while the new tile may be written to MSR 209. When the matrix multiplication using the tiles read from GMR 208 is complete, MXUs 207 may read the new tile from MSR 209 and write the new tile to GMR 208. MXUs 207 may continue this process until the entirety of the matrix multiplication is complete.

User computing device 220 may also be configured similarly to server computing device 210, with one or more processors 221, memory 222, instructions 223, and data 224. User computing device 220 may also include user input 225 and user output 226. User input 225 may include any appropriate mechanism or technique for generating a user input, such as keyboard, mouse, mechanical actuators, soft actuators, touchscreens, microphones, and sensors. User output 226 may additionally include one or more speakers, transducers or other audio outputs, a haptic interface or other tactile feedback that provides non-visual and non-audible information to the platform user of user computing device 220.

User computing device 220 may be configured to transmit data to server computing device 210, and server computing device 210 can be configured to display at least a portion of the received data on a display.

Although FIG. 2 illustrates the processors and the memories as being within the computing devices, components described herein may include multiple processors and memories that can operate in different physical locations and not within the same computing device. For example, some of the instructions and the data may be stored on a removable SD card and others within a read-only computer chip. Some or all of the instructions and data may be stored in a location physically remote from, yet still accessible by, the processors. Similarly, the processors may include a collection of processors that may perform concurrent and/or sequential operation. The computing devices may each include one or more internal clocks providing timing information, which may be used for time measurement for operations and programs run by the computing devices.

Server computing device 210 may be connected over network 230 to data center 240 housing any number of hardware accelerators. Data center 240 may be one of multiple data centers or other facilities in which various types of computing devices, such as hardware accelerators, are located. Computing resources housed in the data center may be specified for using a custom scratchpad memory to determine partial dot product reductions, as described herein.

Data center 240 may include a plurality of hardware accelerators, such as hardware accelerators 260A-N. Hardware accelerators 260A-N can be any type of processor, such as a GPU, FPGA, or ASIC such as a TPU. Aspects of the disclosure may in some examples be implemented as specialized features of general-purpose processors, e.g., as part of a CPU or other processor configured to perform dot product reductions using a custom scratchpad memory, as described herein.

Server computing device 210, user computing device 220, and data center 240 may be capable of direct and indirect communication over the network. For example, using a network socket, user computing device 220 may connect to a service operating on server computing device 210 through an Internet protocol. In some instances, user computing device 220 may connect to a service operating within data center 240. The devices and data center 240 may set up listening sockets that may accept an initiating connection for sending and receiving information, such as user queries and responses to the user queries. The network itself may include various configurations and protocols including the Internet, World Wide Web, intranets, virtual private networks, wide area networks, local networks, and private networks using communication protocols proprietary to one or more companies. The network may support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network may also support wired connections between the devices and the data center, including over various types of Ethernet connection.

Although a single server computing device, user computing device, and data center are shown in FIG. 2, it is understood that the aspects of the disclosure may be implemented according to a variety of different configurations and quantities of computing devices, including in paradigms for sequential or parallel processing, or over a distributed network of multiple devices. In some implementations, aspects of the disclosure may be performed on a single device connected to hardware accelerators configured to optimize partial dot product reduction determinations, and any combination thereof.

Server computing device 210 may be configured to receive user requests from user computing device 220, where the user requests may pertain to a variety of topics. Server computing device 210 may also be configured to receive requests to process data from user computing device 220 using computing resources in data center 240. For example, computing environment 200 may be part of a computing platform configured to provide a variety of services to users, through various user interfaces and/or application programming interfaces (APIs) exposing the platform services. The variety of services may include responding to a received user query, where the response is determined using a custom scratchpad memory for partial dot product reductions. User computing device 220 may transmit the user query to server computing device 210. Server computing device 210 may generate a first matrix, where the first matrix may represent the user query. Server computing device 210 may use portions of the first matrix to perform matrix multiplication against portions of a second matrix. The second matrix may represent model parameter values of a trained model or model being trained, which may be used to generate a response to the user query. Server computing device 210 may multiply portions of the first matrix against portions of the second matrix to generate a partial result of resultant matrix C. Server computing device 210 may store the partial results in the custom scratchpad memory until the matrix multiplication generates the entirety of resultant matrix C. In some examples, the matrices that are multiplied are tensors or portions of tensors.

In some instances, server computing device 210 may read the second matrix from resources, e.g., disc or volatile memory, stored within data center 240. Further, in some examples, service computing device 210 may read the second matrix from memory 202.

As other examples of potential services provided by a platform implementing computing environment 200, server computing device 210 may maintain a variety of models for using the custom scratchpad memory to determine partial dot product reductions in accordance with different constraints available within data center 240. For example, server computing device 210 may maintain different families for deploying models on various types of TPUs and/or GPUs housed in data center 240 or otherwise available for processing.

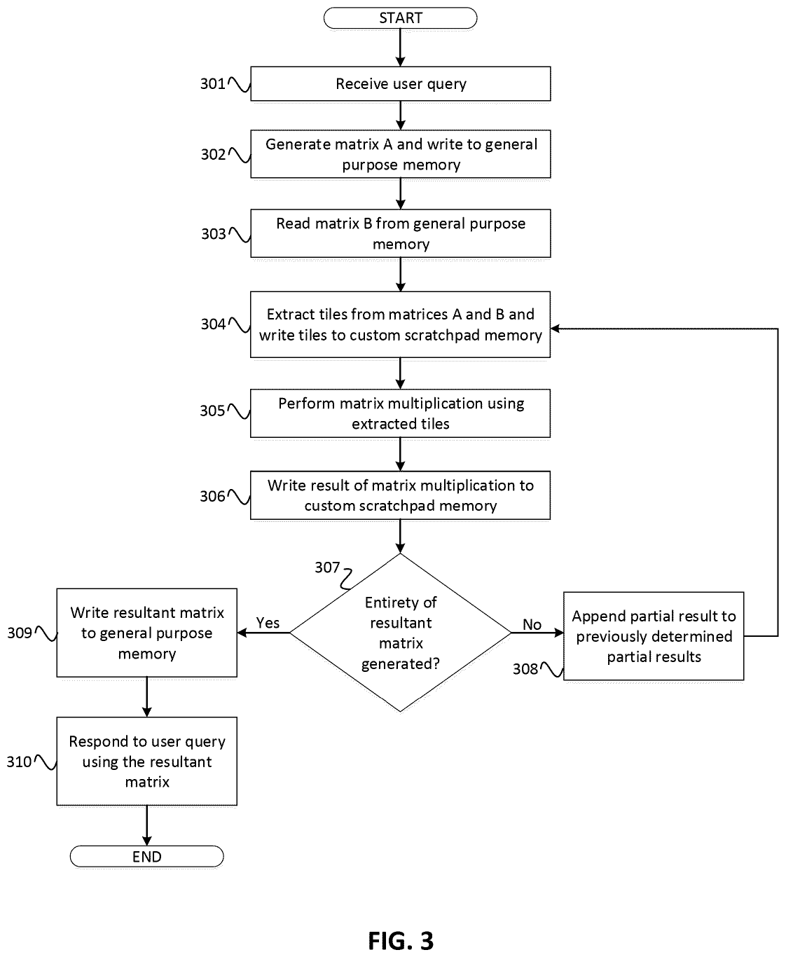

FIG. 3 illustrates a flow diagram for an example method of using the custom scratchpad memory for partial dot product reductions, in accordance with aspects of the disclosure. The operations described herein are presented in the current order by way of example, and the order is not meant to be limiting. Moreover, operations may be omitted from or added to the example method. The method described herein may be performed by devices and components illustrated in example environment 200, such as server computing device 210, user computing device 220, and data center 240. In some examples, the method described herein may be performed with additional or alternative computing devices and components therein.

At block 301, server computing device 210 may receive a user query from user computing device 220. The user query may include a search query, an image, input text, or the like. The user query may include a request for particular information, such as results of the search query, identification of the image, a response to the input text, or the like. Server computing device 210 may generate a response to the received user query by performing matrix multiplication using a first matrix that corresponds to the received user query and a second matrix that corresponds to a trained model or a training model that includes information that may be used to respond to the user query.

At block 302, server computing device 210 may transform the received user query into a matrix representation of the user query, referred to herein as matrix A. Server computing device 210 may write matrix A to memory 202.

At block 303, server computing device 210 may read the second matrix, referred to herein as matrix B, from memory 202. In instances where matrix B is written to data center 240, server computing device 210 may read matrix B from data center 240 and write matrix B to memory 202. In some instances, server computing device 210 may read matrix B from the high bandwidth memory (HBM) therein and may write matrix B to the virtual memory (Vmem) therein.

At block 304, server computing device 210 may read portions of matrices A and B from memory 202, e.g., tiles of matrices A and B where the tile of matrix A may include elements of matrix A and the tile of matrix B may include elements of matrix B. In particular, server computing device 210 may extract a first tile from matrix A and a second tile from matrix B. The first tile and the second tile may be used to perform matrix multiplication of matrices A and B. In some instances, the first tile may include elements of matrix A, such as a first subset of column elements of matrix A. In some instances, the second tile may include elements of matrix B, such as a first subset of row elements of matrix B. Server computing device 210 may write the first tile and the second tile to custom scratchpad memory 205.

At block 305, server computing device 210 may perform matrix multiplication using the first tile extracted from matrix A and the second tile extracted from matrix B. Server computing device 210 may perform the matrix multiplication using at least one array function, such as a matmul ( ) function configured to determine a matrix product of two arrays or sub-matrices, such as the tiles. The matmul ( ) function may be used to determine a partial product tile of resultant matrix C, and may require two tiles to compute the matrix product. To perform the matrix multiplication, the height of the first tile, such as a column tile extracted from matrix A, should match the width of the second tile, such as a row tile extracted from matrix B. For example, a first tile with a height of 128 units may be multiplied against a second tile with a width of 128 units. The product of this multiplication may be a partial result of matrix C, such as a 128×128 tile of matrix C.

At block 306, server computing device 210 may write the partial result of matrix C to custom scratchpad memory 205. For example, server computing device 210 may write the determined tile of resultant matrix C to custom scratchpad memory 205.

At block 307, server computing device 210 may determine whether the entirety of result matrix C was generated in accordance with the described matrix multiplication. To do so, server computing device 210 may determine whether every tile of matrix A was multiplied against every tile of matrix B. In some instances, server computing device 210 may determine whether every column tile of matrix A was multiplied against every row tile of matrix B.

If, at block 307, server computing device 210 determines that the entirety of resultant matrix C has not been generated, then, at block 308, server computing device 210 may append the partial result of matrix C to previously determined partial results of resultant matrix C. In particular, server computing device 210 may append the determined tile of resultant matrix C to previously determined tiles of resultant matrix C. To do so, server computing device 210 may read the previously determined tiles of resultant matrix C from custom scratchpad memory 205 and may append the determined tile of resultant matrix C to the previously determined tiles using, for example, adders.

Server computing device 210 may use the adders to generate fully populated columns or rows of resultant matrix C based on the determined tiles of resultant matrix C. The adders may have read-accumulate-write capabilities. As such, the adders may be configured to read the determined tile of resultant matrix C and the previously determined tiles of resultant matrix C, accumulate the totality of determined tiles of resultant matrix C to generate a partial result of resultant matrix C, and write the partial result of resultant matrix C to custom scratchpad memory 205.

Server computing device 210 may return to block 304 and may repeat the process described herein until each tile of matrix A is multiplied against each tile of matrix B to generate each partial product tile of resultant matrix C. To do so, server computing device 210 may extract an updated first tile from matrix A, where the updated first tile may include new elements, such as column elements, extracted from matrix A. The updated first tile may include different elements, such as different column elements, from those of the first tile. Server computing device 210 may repeat the matrix multiplication using the updated first tile and the second tile. Performing matrix multiplication using the updated first tile and the second tile may result in an additional tile of resultant matrix C. Server computing device 210 may append the additional tile of resultant matrix C to the partial result of resultant matrix C, and may determine whether the entirety of resultant matrix C has been generated. In instances where the entirety of resultant matrix C has not been generated, server computing device 210 may return to block 304. Server computing device 210 may repeat the process described herein until each tile of matrix A is multiplied against the tiles within matrix B.

In some instances, server computing device 210 may return to block 304 and may repeat the process described herein until each tile of matrix B, for example each row tile extracted from matrix B, is multiplied against each tile of matrix A to generate the entirety of resultant matrix C. To do so, server computing device 210 may extract an updated second tile from matrix B, where the updated second tile may include new elements, such as row elements, extracted from matrix B, such as new row elements. The updated second tile may include different elements, such as different row elements, from those in the second tile. Server computing device 210 may repeat the matrix multiplication using the first tile and the updated second tile. Performing matrix multiplication using the first tile and the updated second tile may result in an additional tile of resultant matrix C. Server computing device 210 may append the additional tile of resultant matrix C to the partial result of resultant matrix C, and may determine whether the entirety of resultant matrix C has been generated. In instances where the entirety of resultant matrix C has not been generated, server computing device 210 may return to block 304. Server computing device 210 may repeat the process described herein until the first tile is multiplied against each tile, such as each row tile, extracted from matrix B.

Server computing device 210 may use MXUs 207 and the double buffer to store the updated second tile while the second tile is used to perform the matrix multiplication. The double buffer may store both the tiles that are currently being used to perform the matrix multiplication as well as new tiles to be used to perform the matrix multiplication. In particular, the tiles that are currently in use may be read, by MXUs 207, from GMR 208 while the new tiles may be written to MSR 209. When the matrix multiplication using the tiles read from GMR 208 is complete, MXUs 207 may read the new tiles from MSR 209 and write the new tiles to GMR 208. MXUs 207 may continue this process until the entirety of the matrix multiplication is complete. Upon completion of the matrix multiplication, server computing device 210 may determine whether the entirety of resultant matrix C has been generated. In instances where the entirety of resultant matrix C has not been generated, server computing device 210 may return to block 304.

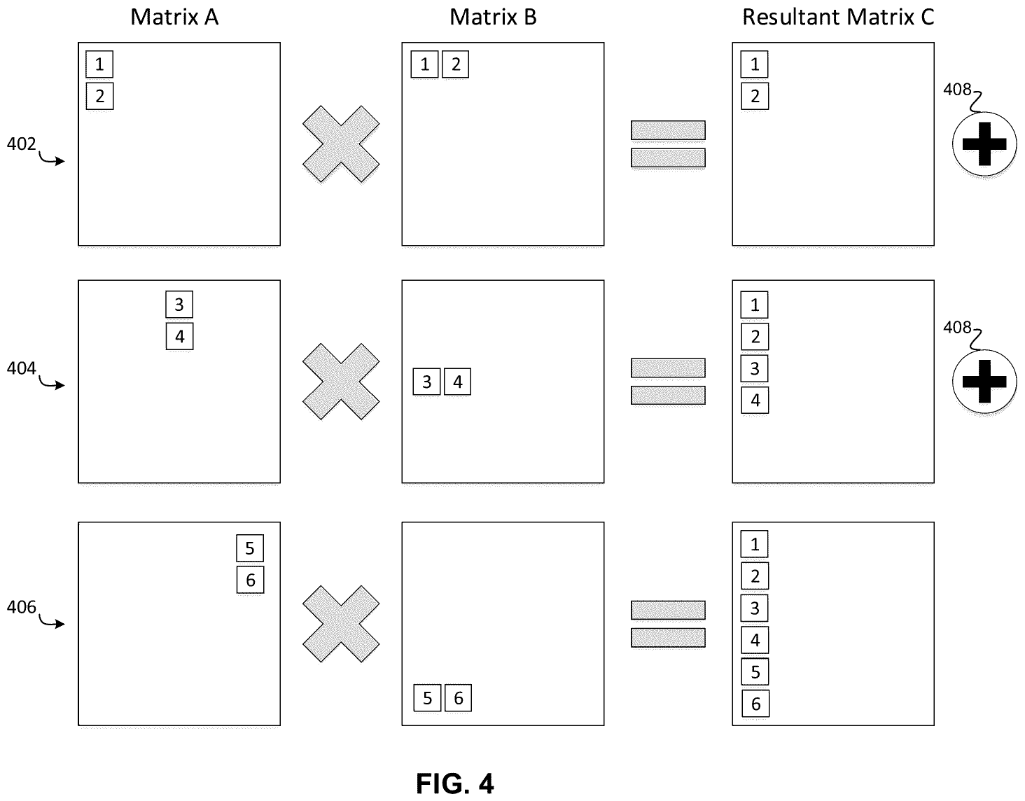

FIG. 4 illustrates an example addition of partial results of a resultant matrix, in accordance with aspects of the disclosure. The example addition illustrated in FIG. 4 features iterations of the matrix multiplication described herein. The example addition of the partial results of the resultant matrix illustrated in FIG. 4 is discussed in conjunction with the example method of FIG. 3.

The first iteration of the matrix multiplication 402 illustrates the matrix multiplication of matrices A and B, where the first tile includes a column tile including elements 1 and 2 of matrix A and the second tile includes a row tile including elements 1 and 2 of matrix B. The matrix multiplication of the first tile and the second tile may produce a partial product tile including elements 1 and 2 of resultant matrix C. In some instances, the first iteration of the matrix multiplication 402 may correspond to an initial iteration of the example method illustrated in FIG. 3. Based on determining the entirety of resultant matrix C has not been generated, server computing device 210 may repeat the described matrix multiplication using updated tiles.

The repeated matrix multiplication using updated tiles may correspond to the second iteration of the matrix multiplication 404, which illustrates the matrix multiplication of matrices A and B, where an updated first tile includes a column tile including elements 3 and 4 of matrix A and an updated second tile includes a row tile including elements 3 and 4 of matrix B. The matrix multiplication of the updated first tile and the updated second tile may produce a partial product tile including elements 3 and 4 of resultant matrix C. The first iteration of the matrix multiplication 402 and the second iteration of the matrix multiplication 404 may be appended using adder 408, resulting in an updated resultant matrix C. The updated resultant matrix C may include partial product tiles including elements 1 to 4 of the first column of the resultant matrix C. In some instances, the second iteration of the matrix multiplication 404 may correspond to a second iteration of the example method illustrated in FIG. 3. Based on determining the entirety of resultant matrix C has not been generated, server computing device 210 may repeat the described matrix multiplication using updated tiles.

The repeated matrix multiplication using updated tiles may correspond to the third iteration of the matrix multiplication 406, which illustrates the matrix multiplication of matrices A and B, where an updated first tile includes a column tile including elements 5 and 6 of matrix A and an updated second tile includes a row tile including elements 5 and 6 of matrix B. The matrix multiplication of the updated first tile and the updated second tile may produce a partial product tile including elements 5 and 6 of resultant matrix C. The second iteration of the matrix multiplication 404 and the third iteration of the matrix multiplication 406 may be appended using adder 408, resulting in an updated resultant matrix C. The updated resultant matrix C may include partial product tile including elements 1 to 6 of the first column of the resultant matrix C. In some instances, the third iteration of the matrix multiplication 406 may correspond to a third iteration of the example method illustrated in FIG. 3.

Server computing device 210 may repeat the example partial result addition illustrated in FIG. 4 until the entirety of resultant matrix C is generated and written to memory 202.

Returning to block 307 of FIG. 3, if server computing device 210 determines that the entirety of resultant matrix C has been generated, then, at block 309, server computing device 210 may read the entirety of resultant matrix C from custom scratchpad memory 205 and may write the entirety of resultant matrix C to memory 202.

At block 310, server computing device 210 may use result matrix C to generate a response to the user query of matrix A and may transmit the generated response to user computing device 220. For example, where matrix A included a user query submitted to an automated chatbot, resultant matrix C may be used to respond to the user query after processing input data of the user query through a trained machine learning model, which can include performing matrix multiplications as described herein. The content of resultant matrix C may be used to update model parameter values, such as those that form at least part of matrix B that is multiplied with matrix A. The updated model can be used to respond to subsequent user queries.

Custom scratchpad memory 205 may be cleared upon termination of the matrix multiplication and the described process may repeat when a subsequent user input is received.

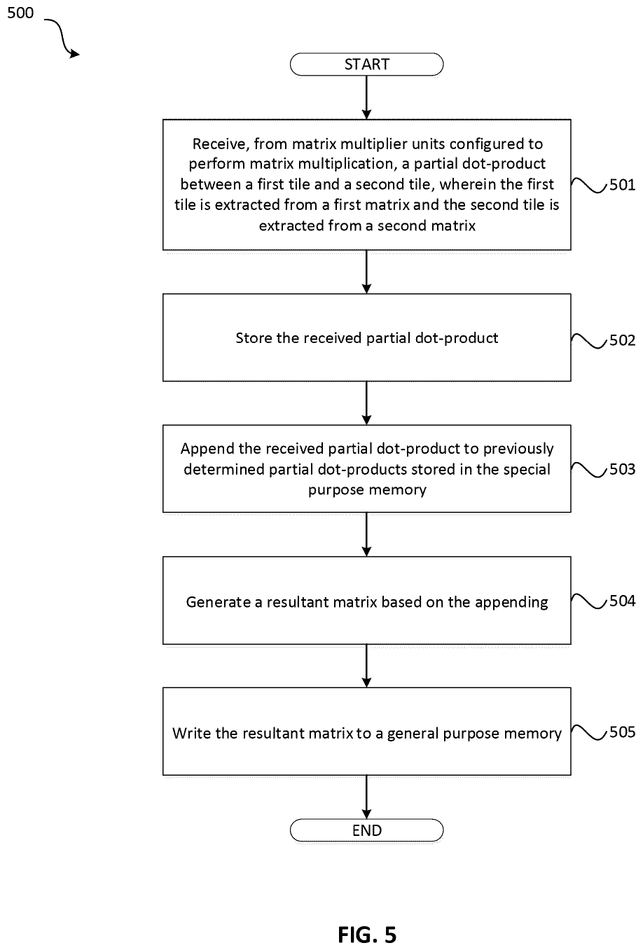

FIG. 5 illustrates an example process or method of using the custom scratchpad memory for partial dot product reductions, in accordance with aspects of the disclosure. The operations described herein are presented in the current order by way of example, and the order is not meant to be limiting. Moreover, operations may be omitted from or added to the example method. The method described herein may be performed by devices and components illustrated in example environment 200, such as custom scratchpad memory 205. In some examples, the method described herein may be performed with additional or alternative computing devices and components therein.

At block 501, custom scratchpad memory 205 may receive, from MXUs 207, a partial dot product between the first tile and the second tile, wherein the first tile may contain column elements extracted from the first matrix and the second tile may contain row elements extracted from the second matrix. As described above, server computing device 210 may use MXUs 207 to perform the matrix multiplication and to store the tiles extracted from the matrices that are currently used to perform the matrix multiplication as well as the updated tiles that will be used to perform the matrix multiplication at some time in the future. In some instances, custom scratchpad memory 205 may store the first and second tiles, and MXUs 207 may read the tiles from custom scratchpad memory 205 to perform the matrix multiplication. Further, in some instances, custom scratchpad memory 205 may store updated first and second tiles, where the updated first tile may include new column elements extracted from the first matrix and the updated second tile may include new row elements extracted from the second matrix.

MXUs 207 may use the first and second tiles as well as the updated first and second tiles to perform the matrix multiplication, wherein each iteration of the matrix multiplication may generate a partial dot product between either the first tile and the second tile, the first tile and the updated second tile, or the updated first tile and the second tile. Upon completion of the matrix multiplication, MXUs 207 may write the determined partial dot products to custom scratchpad memory 205. In some instances, server computing device 210 may write the determined partial dot products to custom scratchpad memory 205.

At block 502, custom scratchpad memory 205 may store the received partial dot products. Custom scratchpad memory 205 may continuously store subsequent partial dot products as they are received from MXUs 207. The received partial dot product and the subsequently received partial dot products may correspond to tiles of the resultant matrix. In some instances, the subsequent partial dot products may correspond to matrix multiplication performed using the updated first tile and the second tile or using the first tile and the updated second tile.

At block 503, custom scratchpad memory 205 may append the received partial dot product to previously determined partial dot products, already stored custom scratchpad memory 205, using adders. To do so, custom scratchpad memory 205 may read from memory the previously received partial dot products and may accumulate each of the previously received partial dot products to create a partial resultant matrix, such as resultant matrix C.

At block 504, custom scratchpad memory 205 may generate the resultant matrix, such as resultant matrix C, based on the appending. As custom scratchpad memory 205 receives subsequent partial dot products, custom scratchpad memory 205 may repeat the process herein to append newly received partial dot product to the partial resultant matrix. Appending additional tiles to the partial resultant matrix may create an updated partial resultant matrix, which custom scratchpad memory 205 may store. Custom scratchpad memory 205 may continue to append the received partial dot products to the updated partial resultant matrix until an entirety of the resultant matrix is generated. The entirety of the resultant matrix may be generated when the entirety of the first matrix is multiplied against the entirety of the second matrix.

At block 505, custom scratchpad memory 205 may write the generated resultant matrix to the general purpose memory, such as memory 202. Memory 202 may use the resultant matrix to generate a response to a user query.

The use of custom scratchpad memory 205 may reduce the number of read transactions from memory 202 and the number of write transactions to memory 202. This may allow server computing device 210 to use memory 202 for additional operations and applications executing on server computing device 210 and may reduce the need for server computing device 210 to compete with the concurrent operations and applications for storage space within memory 202 to perform the matrix multiplication. The use of custom scratchpad memory 205 may transfer the bandwidth consumed by memory 202 to custom scratchpad memory 205, which may increase the efficiency of the matrix multiplication since custom scratchpad memory 205 may be smaller and faster than memory 202 without consuming a large amount of area or power. The use of custom scratchpad memory 205 may reduce an amount of time needed to compute resultant matrix C and may reduce an amount of time needed to respond to the user query based on the resultant matrix C. The use of the adders may reduce the ALU bandwidth, the additional load, and the store bandwidth that may be needed to perform read transactions from and write transactions to memory 202.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed on it software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as a TensorFlow framework.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components, or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back-end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A system for determining partial dot product reductions, the system comprising:
a special purpose memory;
one or more computing devices configured to communicate with the special purpose memory and a general purpose memory; and
instructions that, when executed, cause the one or more computing devices to:
receive, from matrix multiplier units configured to perform matrix multiplication and associated with the one or more computing devices, a partial dot product between a first tile and a second tile, wherein the first tile is extracted from a first matrix and the second tile is extracted from a second matrix;
store the received partial dot product;
append the received partial dot product to previously determined partial dot products stored in the special purpose memory;
generate a resultant matrix based on the appending; and
write the resultant matrix to the general purpose memory.

2. The system of claim 1, wherein the first tile comprises column elements extracted from the first matrix.

3. The system of claim 1, wherein the second tile comprises row elements extracted from the second matrix.

4. The system of claim 1, wherein the instructions, when executed, further cause the one or more computing devices to store the first tile and the second tile.

5. The system of claim 1, wherein the instructions, when executed, further cause the one or more computing devices to store an updated first tile,
wherein the updated first tile comprises new column elements extracted from the first matrix, and
wherein the new column elements of the updated first tile are different from column elements of the first tile.

6. The system of claim 1, wherein the instructions, when executed, further cause the one or more computing devices to store an updated second tile,
wherein the updated second tile comprises new row elements extracted from the second matrix, and
wherein the new row elements of the updated second tile are different from row elements of the second tile.

7. The system of claim 1, wherein the instructions, when executed, further cause the one or more computing devices to receive, from the matrix multiplier units, subsequent partial dot products between:
an updated first tile and the second tile; and
the first tile and an updated second tile.

8. The system of claim 1, wherein the instructions, when executed, further cause the one or more computing devices to store subsequent partial dot products received from the matrix multiplier units.

9. The system of claim 1, wherein each of the partial dot product and subsequent partial dot products correspond to tiles of the resultant matrix.

10. The system of claim 9, wherein the appending further causes the one or more computing devices to:
locate, within the special purpose memory, the tiles of the resultant matrix, wherein the tiles are based on the partial dot product and the subsequent partial dot products; and
accumulate, using adders, the located tiles to create a partial resultant matrix until a totality of the located tiles generates the resultant matrix.

11. The system of claim 10, wherein the instructions, when executed, cause the one or more computing devices to:
store the partial resultant matrix; and
append, using the adders, additional tiles of the resultant matrix to the stored partial resultant matrix to generate an updated partial resultant matrix until the resultant matrix is generated.

12. The system of claim 1, wherein the instructions, when executed, further cause the one or more computing devices to append, using adders, the received partial dot product to previously determined partial dot products until a totality of receive partial dot products indicates that an entirety of the first matrix was multiplied against an entirety of the second matrix.

13. A method for determining partial dot product reductions using a special purpose memory, the method comprising:
receiving, by the special purpose memory and from matrix multiplier units configured to perform matrix multiplication, a partial dot product between a first tile and a second tile, wherein the first tile is extracted from a first matrix and the second tile is extracted from a second matrix;
storing, by the special purpose memory, the received partial dot product;
appending, by the special purpose memory, the received partial dot product to previously determined partial dot products stored in the special purpose memory;
generating, by a computing device comprising the special purpose memory, a resultant matrix based on the appending; and
writing, by the computing device, the resultant matrix to a general purpose memory.

14. The method of claim 13, further comprising receiving, by the special purpose memory and from the matrix multiplier units, subsequent partial dot products between:
an updated first tile and the second tile, wherein the updated first tile comprises new column elements extracted from the first matrix, and wherein the new column elements of the updated first tile are different from column elements of the first tile; and
the first tile and an updated second tile, wherein the updated second tile comprises new row elements extracted from the second matrix, and wherein the new row elements of the updated second tile are different from row elements of the second tile.

15. The method of claim 13, wherein each of the partial dot product and subsequent partial dot products correspond to tiles of the resultant matrix.

16. The method of claim 15, wherein the appending further comprises:
locating, by the special purpose memory, the tiles of the resultant matrix, wherein the tiles are based on the partial dot product and the subsequent partial dot products; and
accumulating, by the special purpose memory and using adders, the located tiles to create a partial resultant matrix until a totality of the located tiles generates the resultant matrix.

17. The method of claim 16, further comprising:
storing, by the special purpose memory, the partial resultant matrix; and
appending, by the special purpose memory and using the adders, additional tiles of the resultant matrix to the stored partial resultant matrix to generate an updated partial resultant matrix until the resultant matrix is generated.

18. A non-transitory computer readable storage medium storing instructions that, when executed by a computing device comprising one or more processors, special purpose memory, and general purpose memory, cause the computing device to:
receive, from matrix multiplier units configured to perform matrix multiplication, a partial dot product between a first tile and a second tile, wherein the first tile is extracted from a first matrix and the second tile is extracted from a second matrix;
store the received partial dot product in the special purpose memory;
append the received partial dot product to previously determined partial dot products stored in the special purpose memory;
generate a resultant matrix based on the appending; and
write the resultant matrix to the general purpose memory.

19. The non-transitory computer readable storage medium of claim 18 storing instructions that, when executed, further cause the computing device to store the first tile and the second tile in the special purpose memory.

20. The non-transitory computer readable storage medium of claim 18 storing instructions that, when executed, further cause the computing device to receive, from the matrix multiplier units, subsequent partial dot products between:
an updated first tile and the second tile, wherein the updated first tile comprises new column elements extracted from the first matrix, and wherein the new column elements of the updated first tile are different from column elements of the first tile; and
the first tile and an updated second tile, wherein the updated second tile comprises new row elements extracted from the second matrix, and wherein the new row elements of the updated second tile are different from row elements of the second tile.
